(19) United States
(12) Patent Application Publication
(10) Pub. No.: US 2005/0080745 A1
(43) Pub. Date: Apr. 14, 2005

(54) Electronic licensing for device tester

(76) Inventor: Reid F. Hayhow, LaPorte, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/684,281

(22) Filed: Oct. 10, 2003

(51) Int. Cl. G06F 17/60

(52) U.S. Cl. 705/59

(57) ABSTRACT

Electronic licensing of a device tester is disclosed. In one embodiment, a method is disclosed that comprises sending an electronic license to enable a device tester, receiving at least one log file having resource use information for one or more tests executed on the device tester using the electronic license, and generating a bill from the at least one log file.

### BACKGROUND OF THE INVENTION

Prior to shipping a device, such as a system-on-a-chip (SOC), the device must be tested to determine whether it has been manufactured correctly and is fully operational. A variety of testers are available for such testing. Typically, a tester is a very large and expensive machine which is designed to precisely position the placement of logic signal transitions at very high speeds.

The tester may be used to subject a device to functional, structural, or other types of tests. Each type of test that may be applied to a device may use a different amount of resources, such as memory and speed, on the tester. Additionally, the resource use may vary between different tests of each type. Currently, customers must pay in advance to have a desired amount of resources made available to the tester during device testing.

### SUMMARY OF THE INVENTION

Methods and systems for electronic licensing of a device tester are disclosed. In one embodiment, the method comprises sending an electronic license to enable a device tester. At least one log file is then received that has resource use information for one or more tests executed on the device tester using the electronic license. A bill is then generated from the at least one log file.

### BRIEF DESCRIPTION OF THE DRAWINGS

Illustrative embodiments of the invention are illustrated in the drawings in which:

FIG. 1 illustrates an exemplary plan view of a system having an electronic license that may be used to test a device;

FIG. 2 illustrates an exemplary method that may be used to generate a bill for resources used during device testing; and

FIG. 3 illustrates an exemplary method that may be used to generate a usage report for resources used during device testing.

### DETAILED DESCRIPTION

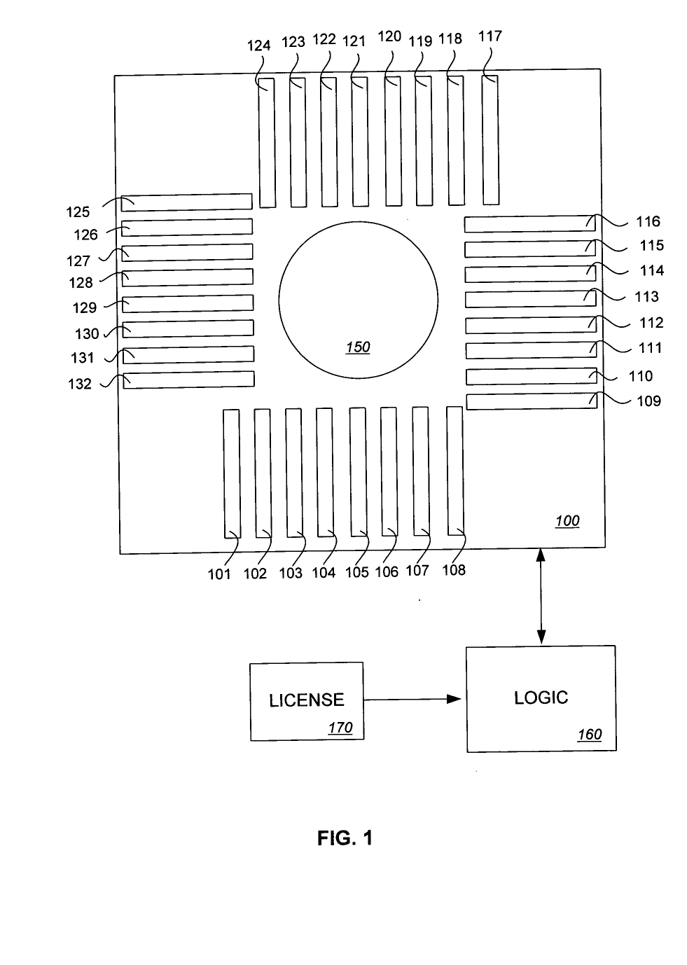

An exemplary embodiment of a system having an electronic license that may be used to test a device is illustrated in FIG. 1. The system includes a tester 100 to test a device 150. By way of example, device 150 may be a system-on-a-chip (SOC). It should be appreciated that at times, tester 100 will not be coupled to a device 150.

Tester 150 includes a plurality of boards 101-132. Each board may include a plurality of pins (not shown) that may be used to drive inputs and receive outputs from device 150. In one embodiment, each pin may include its own memory to use during the testing of the device. The memory may be used to store pin specific vector information. In alternate embodiments, memory may not be included on each pin, but may instead be included for each board or other component of tester 100.

The system also includes logic 160 communicatively coupled to tester 100. Logic 160 may be part of a test operating system on a workstation coupled to tester 100 via a communication link, such as an optical link. In one embodiment, logic 160 may communicate with firmware (not shown) on tester 100 to send tests to device 150 and receive test results. In an alternate embodiment, logic 160 may be part of the firmware of tester 100.

Logic 160 may be used to enable the tester 100 according to one or more properties associated with an electronic license 170. Electronic license 170 may be used to enable all of the capabilities of the tester 100 or may be used to grant limited use of resources on the tester 100. By way of example, the electronic license 170 may be used to enable an amount of memory, such as vector or result memory, available on the tester 100 for tests performed on device 150. The memory made available may be for the entire tester 100, for individual boards 101-132 of a tester, for individual pins of the tester, or for other component of the tester. In some embodiments, the amount of memory made available may vary between components (e.g., boards or pins) of the tester.

It should be appreciated that resources other than memory may also be enabled or governed by properties of the electronic license 170. For example, the speed at which tests may be sent to device 150 may be governed by the electronic license 170. Additional resources available during testing, such as the number of waveforms that can be stored on the tester or component (e.g., board) of the tester and/or the number of edge transitions available in a clock cycle may also be governed by the electronic license 170.

Logic 160 may also be used to create one or more log files containing resource use information for one or more tests executed on the tester 100 using electronic license 170. As will be described in further detail below, these log files may be used by an owner or manager of the tester 100 to bill for the use of tester resources after the tests have been executed. Alternately, or in addition, these log files may be used to generate usage reports that may be used by vendors of test services to bill their customers.

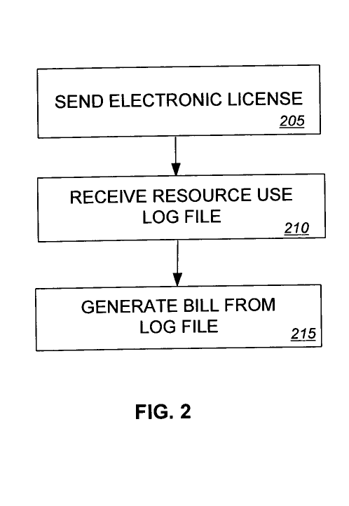

FIG. 2 illustrates an exemplary method that may be used to generate a bill for resources used during device testing. An electronic license 170 is sent 205. As previously discussed, the electronic license may be use to enable tester 100 to perform tests on device 150. The electronic license may also be optionally used to govern a resource allotment available to tests using device tester 100.

By way of example, in some embodiments, the existing memory allotment may not be equal to a maximum amount of memory available in the tester 100 or components of tester 100. For business reasons, customers may only choose to purchase (and have available) a smaller amount of memory than the physical memory available in the tester. Therefore, the license may be used to limit access to the amount of memory purchased by the customer. The memory allotment may be for the entire tester 100, for one or more boards 101-132 of the tester, for one or more pins on the tester, or for another component of the tester.

The license may be also be used to limit the speed available for sending test vectors to device 150 or to limit access to another resource of the tester 100 (e.g., number of waveforms stored on a board or edge transitions available in a clock cycle). It should be appreciated that to increase or decrease a resource allotment made available to tests executed on tester 100, the owner or manager of the tester 100 could send an updated license with the increased or decreased capabilities.

After the license has been sent, one or more log files that contain resource use information for tests executed on the tester 100 using electronic license 170 are received 210. By way of example, the log files may contain information on the amount of time the tester 100 was used, the amount of memory used during testing of device 150 (e.g., the maximum amount of memory used over a predefined period of time, such as the maximum amount of memory used every minute), and the speed at which tests were executed. It should be appreciated that the information on the log file may vary depending upon the configuration of the tester 100, the manner in which resources are allocated on the tester 100, and/or a billing scheme used to charge for the use of tester 100. It should be appreciated that the log files may be encrypted to prevent tampering.

The log file(s) is then used to generate 215 a bill for the use of tester 100. Thus, the electronic licensing of tester 100 allows a customer to be billed after using the tester 100 for resources used during device testing. In some embodiments, the customer may be required to renew or update the license 170 on a periodic basis to prevent billing fraud or other misuse. As previously described updated licenses may also be used to increase or decrease a resource allotment (e.g., memory or speed) made available on the tester 100.

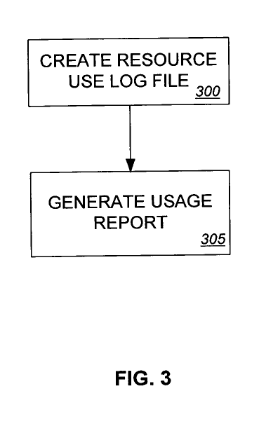

FIG. 3 illustrates an exemplary method that may be used to generate a usage report of resources used by tester 100 during testing of devices. One or more log files are created 300 that contain resource use information for one or more tests executed on tester 100. As previously described the log file(s) may contain information on the amount of time the tester 100 was used, the amount of memory used during testing of device 150 (e.g., the maximum amount of memory used over a predefined period of time, such as the maximum amount of memory used every minute), and the speed at which tests were executed. Other types of resource information are also contemplated. The log file(s) may also contain other types of information on the use of tester 100, such as the name of the workstation from which tests were generated, the name of the user running the tests, description of the tests, and other test information. In some embodiments, the log files may be created 300 in encrypted format to prevent tampering.

A usage report is then generated 305 based on the log file(s). In one embodiment, the log file(s) may be created 300 on a first machine and the usage report may be generated 305 on a second machine. By way of example, the usage report may be generated by value added software provided. The usage report may be used to allow a customer to bill or provide an accounting for device testing performed for one or more third parties. The usage report may alternately or additionally provide an advanced notice of the amount a customer of tester 100 will be charged for resources used. It should be appreciated that logic 160 may also be used to generate the usage report.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method comprising:
sending an electronic license to enable a device tester;
receiving at least one log file having resource use information for one or more tests executed on the device tester using the electronic license;
generating a bill from the at least one log file.

2. The method of claim 1, further comprising after a predetermined period of time, renewing the license by sending a second electronic license to enable the device tester.

3. The method of claim 1, further comprising sending a second electronic license to increase a resource allotment of the device tester.

4. The method of claim 3, wherein the resource allotment comprises an amount of memory available on the device tester.

5. The method of claim 3, wherein the resource allotment comprises a speed available on the device tester.

6. The method of claim 3, wherein the resource allotment comprises a number of waveforms available on the device tester.

7. The method of claim 3, wherein the resource allotment comprises a number of edge transitions available in a clock cycle.

8. A method comprising:
creating at least one log file having resource use information for one or more tests executed on a device tester; and
generating a usage report based on the at least one log file.

9. The method of claim 8, further comprising creating a bill using the usage report.

10. The method of claim 8, wherein the resource use information includes memory used to execute the one or more tests.

11. The method of claim 8, wherein the resource use information includes speed used to execute the one or more tests.

12. The method of claim 8, wherein the at least one log file includes a user name associated with the one or more tests executed on the device tester.

13. The method of claim 6, wherein the device tester comprises a system-on-a-chip (SOC) tester.

14. A system comprising:
a tester to apply one or more tests to a device; and
logic, communicatively coupled to the tester, to enable one or more resources of the tester according to one or more properties of an electronic license and to create at least one log file having resource use information for one or more tests executed on the tester.

15. The system of claim 14, wherein the logic is to enable an amount of memory available on the tester according to one of the properties of the electronic license.

16. The system of claim 14, wherein the logic is to enable a speed available on the tester according to one of the properties of the electronic license.

17. The system of claim 14, wherein the logic is to enable a number of waveforms available on the tester according to one of the properties of the electronic license.

18. The system of claim 14, wherein the logic is to enable a number of edge transitions available on the tester according to one of the properties of the electronic license.

19. The system of claim 14, wherein the tester comprises a system-on-a-chip (SOC) tester.
